(19) United States
(12) Patent Application Publication
(10) Pub. No.: US 2016/0034323 A1
(43) Pub. Date: Feb. 4, 2016

(54) CHARACTERIZING RELATIONSHIPS AMONG SPATIO-TEMPORAL EVENTS

(71) Applicant: International Business Machines Corporation, Armonk, NY (US)

(72) Inventors: Arun Hampapur, Norwalk, CT (US); Anuj Karpatne, Minneapolis, MN (US); Hongfei Li, Briarcliff Manor, NY (US); Xuan Liu, Yorktown Heights, NY (US); Robin Lougee, Yorktown Heights, NY (US); Buyue Qian, Ossining, NY (US); Songhua Xing, Staten Island, NY (US)

(21) Appl. No.: 14/450,792

(22) Filed: Aug. 4, 2014

(51) Int. Cl. G06F 9/54; G06F 17/30

(52) U.S. Cl. CPC G06F 9/542; G06F 17/30598; G06F 17/3087; G06F 17/30551

(57) ABSTRACT

A method of characterizing relationships among spatio-temporal events and a system to characterize the relationships are described. The method includes receiving information specifying the spatio-temporal events and associated categories from one or more sources. The method also includes building, using a processor, a directed acyclic graph (DAG) indicating a relationship among the categories for each of two or more space lag (SL) and time lag (TL) sets. Each of the two or more SL and TL sets defines a spatio-temporal boundary such that only the spatio-temporal events and the associated categories with (SL,TL)-neighborhoods inside the respective spatio-temporal boundary are considered in building the respective DAG. The respective (SL,TL)-neighborhood of each of the spatio-temporal events is a polygonal shape defined by the respective SL and the respective TL and the respective (SL,TL)-neighborhood of each of the categories is a union of the (SL,TL)-neighborhoods of the associated spatio-temporal events.

### BACKGROUND

The present invention relates to spatio-temporal prediction, and more specifically, to characterizing relationships among space-time events.

Spatio-temporal data refers to data that provides information about both location and time. Current technology has increased the availability of spatio-temporal data. For example, global positioning system (GPS) receivers provide location information associated with time. Consequently, the use of data analytics on spatio-temporal data and applications for the analytics are also increasing. One such application is spatio-temporal prediction or the prediction of a location and time range for an event. Exemplary spatio-temporal predictions pertain to the likelihood of crime, traffic congestion, and epidemic spread characterization.

### SUMMARY

According to one embodiment of the present invention, a method of characterizing relationships among spatio-temporal events includes receiving information specifying the spatio-temporal events and associated categories from one or more sources; and building, using a processor, a directed acyclic graph (DAG) indicating a relationship among the categories for each of two or more space lag (SL) and time lag (TL) sets, each of the two or more SL and TL sets defining a spatio-temporal boundary such that only the spatio-temporal events and the associated categories with (SL,TL)-neighborhoods inside the respective spatio-temporal boundary are considered in building the respective DAG, the respective (SL,TL)-neighborhood of each of the spatio-temporal events being a polygonal shape defined by the respective SL and the respective TL and the respective (SL,TL)-neighborhood of each of the categories being a union of the (SL,TL)-neighborhoods of the associated spatio-temporal events.

According to another embodiment, a system to characterize relationships among spatio-temporal events includes an input interface configured to receive information specifying the spatio-temporal events and associated categories from one or more sources; and a processor configured to build a directed acyclic graph (DAG) indicating a relationship among the categories for each of two or more space lag (SL) and time lag (TL) sets, each of the two or more SL and TL sets defining a spatio-temporal boundary such that only the spatio-temporal events and the associated categories with (SL,TL)-neighborhoods inside the respective spatio-temporal boundary are considered in building the respective DAG, the respective (SL,TL)-neighborhood of each of the spatio-temporal events being a polygonal shape defined by the respective SL and the respective TL and the respective (SL,TL)-neighborhood of each of the categories being a union of the (SL,TL)-neighborhoods of the associated spatio-temporal events.

According to yet another embodiment, a computer program product comprises instructions that, when processed by a processor, cause the processor to implement a method of characterizing relationships among spatio-temporal events. The method includes obtaining, from one or more sources, information specifying the spatio-temporal events and associated categories; and building a directed acyclic graph (DAG) indicating a relationship among the categories for each of two or more space lag (SL) and time lag (TL) sets, each of the two or more SL and TL sets defining a spatio-temporal boundary such that only the spatio-temporal events and the associated categories with (SL,TL)-neighborhoods inside the respective spatio-temporal boundary are considered in building the respective DAG, the respective (SL,TL)-neighborhood of each of the spatio-temporal events being a polygonal shape defined by the respective SL and the respective TL and the respective (SL,TL)-neighborhood of each of the categories being a union of the (SL,TL)-neighborhoods of the associated spatio-temporal events.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates an exemplary directed acyclic graph (DAG) generated in accordance with embodiments of the invention;

FIG. 2 is a block diagram of a system to develop a DAG according to embodiments of the invention;

FIG. 3 is a process flow of a method of developing a directed acyclic graph (DAG) according to an embodiment of the invention;

FIG. 4 is an exemplary illustration of the process of building a DAG according to embodiments of the invention;

FIG. 5 illustrates the space lag (SL) and time lag (TL) used to estimate statistical significance according to an embodiment of the invention; and

FIG. 6 shows active events in category A, in a sub-region for a given TL window, used to compute a volume according to an embodiment of the invention.

### DETAILED DESCRIPTION

As noted above, spatio-temporal data is used in spatio-temporal prediction applications. Many spatio-temporal events are related to other events. For example, the closing time and location of a bar may be related to certain crimes in the vicinity of the location. Therefore, the prediction of one type (category) of event may be improved by understanding the relationships among different categories of events. Embodiments of the system and method detailed herein relate to characterizing relationships among spatio-temporal events and, more specifically, among categories of events.

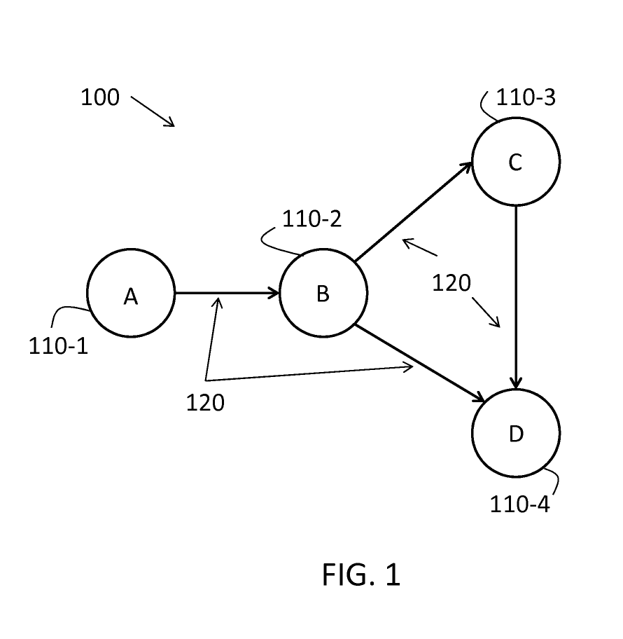

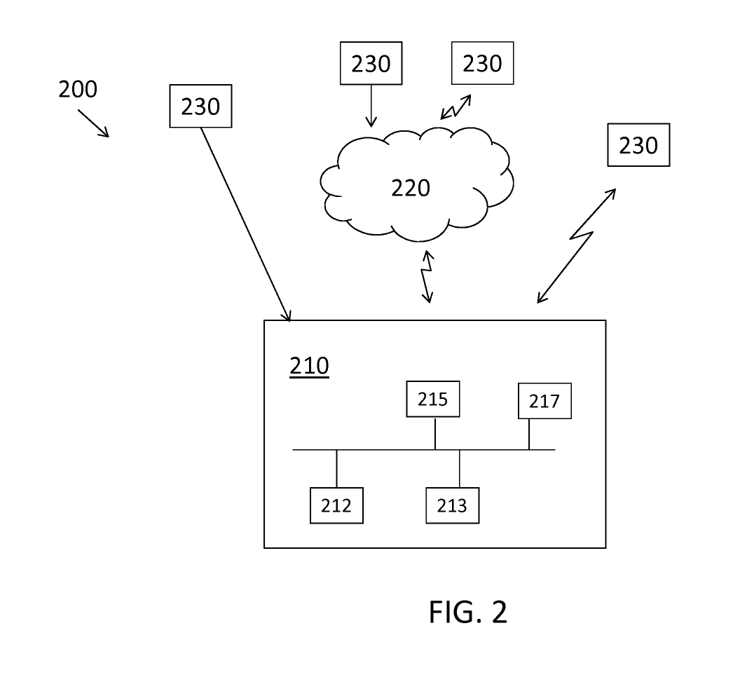

FIG. 1 illustrates an exemplary directed acyclic graph (DAG) 100 generated in accordance with embodiments of the invention. A DAG 100 illustrates the relationships among event categories 110. Event category A 110-1, category B 110-2, category C 110-3, and category D 110-4 (110, generally) are shown. The ordering of the relationships among the categories 110 is indicated by the connecting arrows or edges 120. Thus, as indicated by the exemplary DAG 100 of FIG. 1, events in category A 110-1 influence events in category B 110-2, events in category B 110-2 influence events in both categories C 110-3 and D 110-4, and events in category C 110-3 also influence events in category D 110-4. The ordering addresses spatial lags and temporal lags between events. That is, a temporal lag in events of category B 110-2 with respect to events in category A 110-1 suggests that events in category A 110-1 influence events in category B 110-2. However, considering only spatial and temporal lags may lead to false identification of relationships, or too small a lag may be considered such that relationships are not properly identified. The embodiments discussed below detail the development of a DAG 100 based on considering the statistical significance among spatio-temporal data obtained from one or more sources (230, FIG. 2).

FIG. 2 is a block diagram of a system 210 to develop a DAG 100 according to embodiments of the invention. The system 210 receives spatio-temporal data from various sources 230. The datasets from the sources 230 are comprised of events associated with an event type or category 110. The sources 230 may communicate with the system 210 directly or through a network 220 wirelessly or through cables. The system 210 includes an input interface 212 to communicate with the various sources 230 and a user of the system via a keyboard or touchscreen, for example. The system 210 also includes one or more memory devices 213, one or more processors 215, and an output interface 217. The spatio-temporal data obtained from the sources 230 may be stored in the memory device 213 prior to processing. The output interface 217 may include, for example, a monitor or a transmitter to send the relationship information to another system that may complete the prediction process. The components of the system 210 may be coupled directly or through one or more busses. The processes implemented by the one or more processors 215 of the system 210 to develop the one or more DAGs 100 for a given set of spatio-temporal data are discussed below.

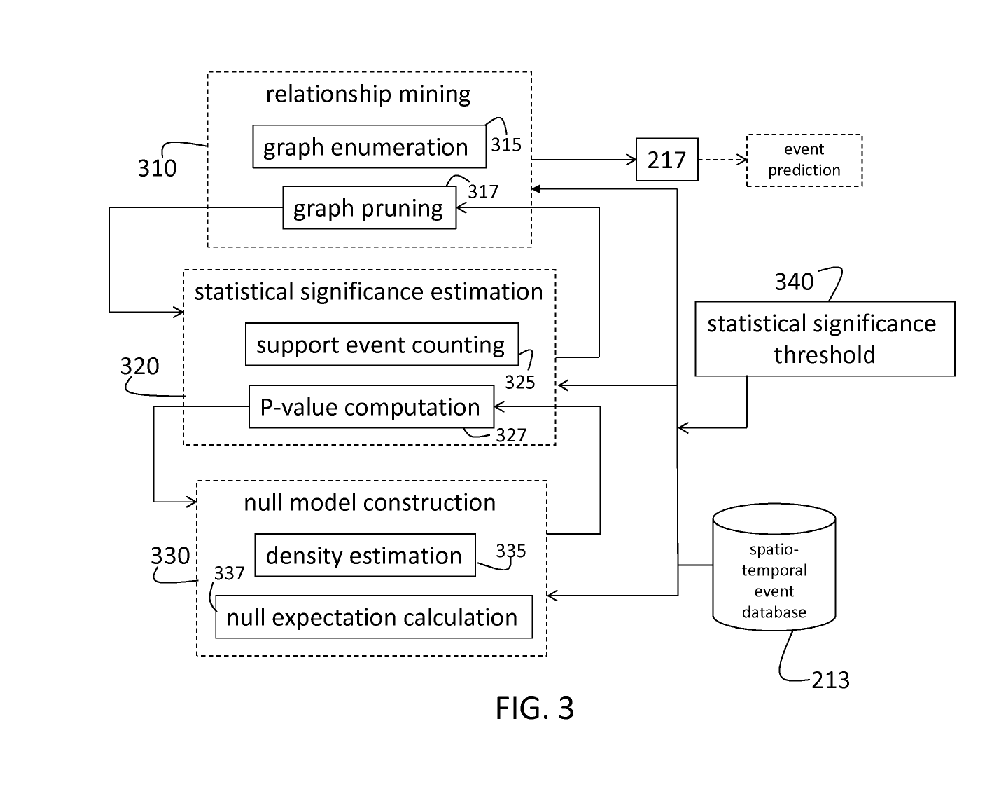

FIG. 3 is a process flow of a method of developing a directed acyclic graph (DAG) 100 according to an embodiment of the invention. The processes are executed by the processor 215 of the system 210 based on receiving spatio-temporal data from sources 230. The processes begin and end in the relationship mining portion 310. The relationship mining portion 310 pertains to representing significant relationships among event categories 110 represented as nodes of a DAG 100 with ordered relationships represented by edges 120. Only relationships among the categories 110 are considered. That is, relationships within a category 110 are not considered so that edges 120 do not begin and end at the same category 110. The determination of significance of a relationship is done by the statistical significance estimation portion 320, which uses the null model construction portion 330. Each of the portions 310, 320, 330 is detailed below. Each of the relationship mining portion 310, the statistical significance estimation portion 320, and null model construction portion 330 accesses the spatio-temporal data obtained from the sources 230. As shown in FIG. 3, the spatio-temporal data may be stored in the memory device 213 of the system 210. Another input is a statistical significance threshold 340, which may be input by a user through the input interface 212. The processor 215 steps through the portions 310, 320, 330 iteratively to develop the one or more DAGs 100 as detailed below. The DAG(s) 100 resulting from the processes shown in FIG. 3 may be output through the output interface 217 to a system that performs the event prediction or the processor 215 may use the relationship information (DAG(s) 100) to perform event prediction.

At block 315, graph enumeration begins the process of building the DAG 100 with an empty set (no edges 120). At each iteration, an edge 120 is added. Then the process of graph pruning, at block 317, is implemented to determine if the new edge 120 should be retained or removed. The pruning process requires the processes of the statistical significance estimation portion 320 which, in turn, calls processes of the null model construction portion 330. The graph pruning at block 317 removes a statistically insignificant edge 120, as detailed below. When N is the number of event categories 110 available, the maximum possible number of edges 120 for a resulting DAG 100 is:

$$max\_k = \frac{N ( N - 1 )}{2} \qquad [ EQ . 1 ]$$

The development of a DAG 100 (statistical significance check of each edge 120) is specific for a given space lag SL and time lag TL (SL,TL), as further discussed below. That is, two categories 110 that are related within one (SL,TL) range may not be related within a narrower (SL,TL) range. For example, SL may vary from 0 meters to 1 kilometer in increments of 50 meters, and TL may vary from 0 to 48 hours in increments of 2 hours. The number of (SL,TL) combinations considered and the SL and TL ranges themselves may be based on the application (type of event being predicted), a user input, or a combination. Thus, a given set of categories 110 may result in multiple different DAGs 100 for multiple different (SL,TL) combinations. The processes of the method shown in FIG. 3 may be generally represented (for an iteration associated with one (SL,TL)) as the following:

For size of DAG = k, where k varies from 0 to max_k

For each DAG, D, of size k,

For each acyclic edge, E, that can be added to D

construct D* by adding E to D
compute the statistical significance of D*
if statistical significance of D* ≧ statistical significance

threshold for the given (SL,TL)

add D* to the set of DAGs of size k+1

else, prune D*

end

end

end

As indicated above, at each iteration, a candidate edge 120 is added to the DAG 100 (D) to generate one or more candidate DAGs 100 (D*). The statistical significance of the candidate edge 120 is determined to determine whether the candidate edge 120 is pruned or retained. Specifically, as detailed below, a number of support events associated with the candidate edge 120 is determined and an expected number of support events based on a null hypothesis (a hypothesis of no relation between the categories 110 connected by the candidate edge 120) is determined, and the statistical significance of the candidate edge 120 is expressed as a probability (P-value), for example, based on the number of support events and the expected number of support events. When this statistical significance exceeds a threshold statistical significance (340), the candidate edge 120 is retained.

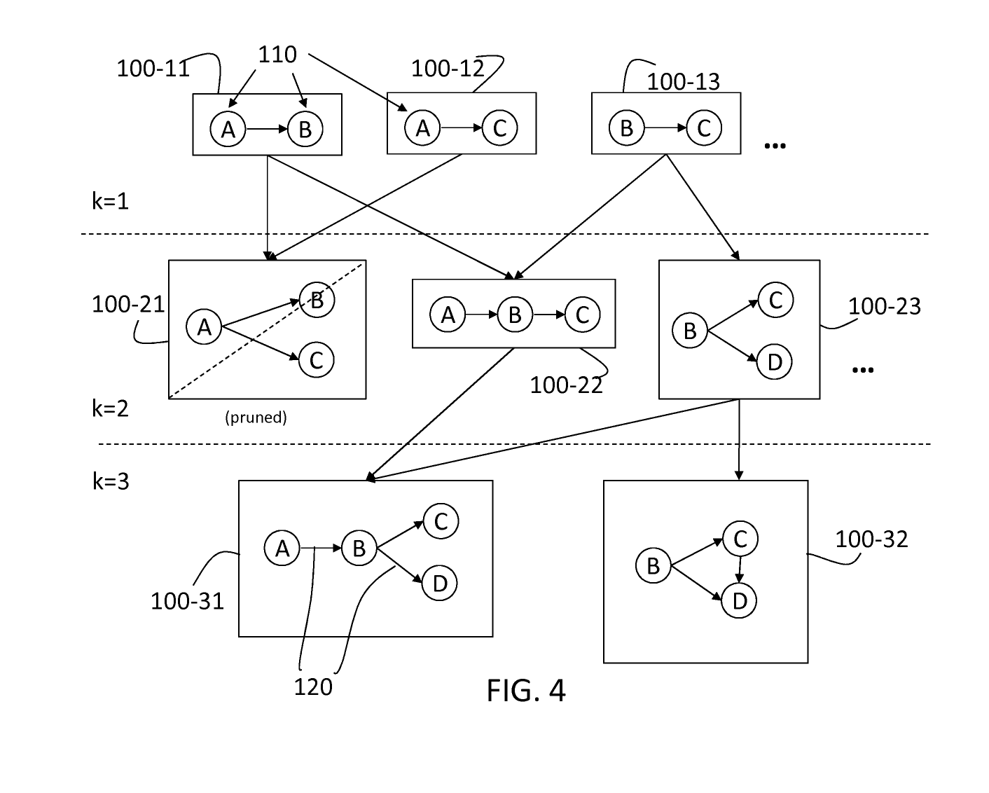

FIG. 4 is an exemplary illustration of the process of building a DAG 100 according to embodiments of the invention. Specifically, FIG. 4 illustrates the loop above for intermediate DAGs 100 with three different numbers of edges 120 (k=1, k=2, and k=3) and shows the development of the DAG 100 shown in FIG. 1. In this case, using EQ. 1 with N=4 (four event categories 110 A, B, C, D), max_k or the maximum possible edges 120 in the DAG 100 is six. Three intermediate DAGs 100-11, 100-12, 100-13 are shown with one edge 120 (k=1). However, as indicated by the dots, more intermediate DAGs 100 (in fact, every intermediate DAG 100) with one edge 120 (A→D, B→D, C→D) are considered in the development process. Another edge 120 is added to each of the intermediate DAGs 100 with k=1 to create intermediate DAGs 100-21, 100-22, 100-23, as shown. Again, other DAGs 100 with k=2 are not shown but are considered (e.g., A→B→D, A→C→D). As FIG. 4 indicates, DAG 100-21 is pruned in a process described below. Referring to the other (not shown) DAGs 100 one level up (k=1), A→D is also pruned. DAG 100-21, which is pruned, results from a combination of DAG 100-11 and DAG 100-12. DAG 100-22 results from a combination of DAG 100-11 and DAG 100-13. When another edge 120 is added (k=3), DAG 100-22 and DAG 100-23 are combined to generate DAG 100-31, and DAG 100-23 is combined with a (not shown) DAG 100 (B→C→D) to generate DAG 100-32. The combination of DAG 100-31 and DAG 100-32 results in the DAG 100 shown in FIG. 1. As noted above, with N=4 and using EQ. 1, the maximum possible edges 120 in this case is six. However, because A→D and A→C are pruned in the development process, the resulting DAG 100 (shown in FIG. 1) has four edges 120.

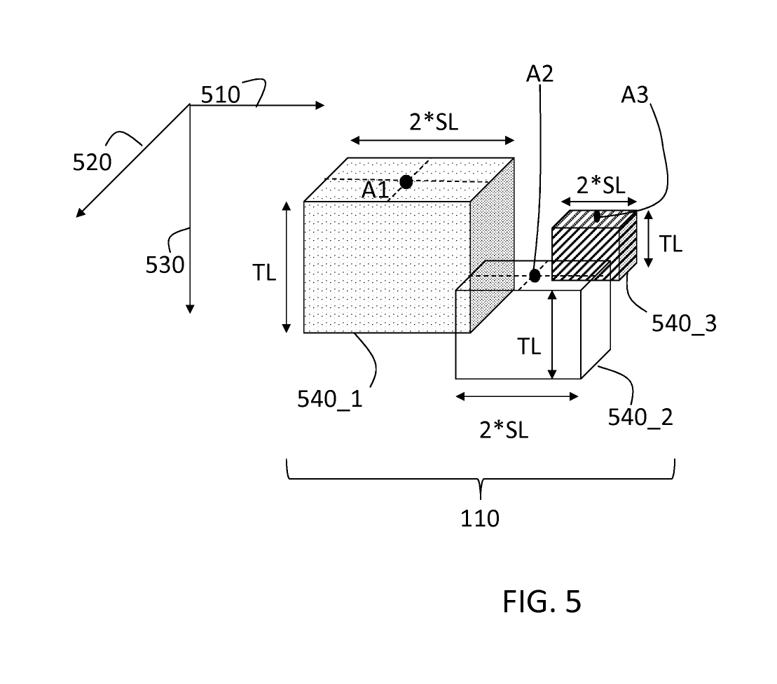

FIG. 5 illustrates the space lag (SL) and time lag (TL) used to estimate statistical significance according to an embodiment of the invention. As shown in FIG. 3, the graph pruning (317) requires results of processes of the statistical significance estimation portion 320. Those processes of the statistical significance estimation portion 320 are discussed next. Two-dimensional space dimensions one and two are shown along axes 510 and 520, and time is shown along axis 530. An exemplary event category 110 is shown to include three events A1, A2, A3, each corresponding with a time and location of an occurrence of an event in the category 110. Each event A1, A2, A3 is the center of a base of a bounding polygon (cuboid 540_1, 540_2, 540_3, respectively) with an area that is a function of the spatial lag SL and a height that is the temporal lag TL. For each (SL,TL) combination being considered, the (SL,TL)-neighborhood for each event A1, A2, A3 is given by the cuboid 540_1, 540_2, 540_3, respectively. For a given event category 110, the (SL,TL)-neighborhood is a union of the (SL,TL)-neighborhood of each event of the category 110. That is, for the category 110 shown in FIG. 5, the (SL,TL)-neighborhood is a union of the cuboids 540_1, 540_2, 540_3. In alternate embodiments, the polygonal shape defining an (SL,TL)-neighborhood need not be a cuboid and may be, for example, a cylinder with a radius defined by SL and a length defined by TL.

For a given edge 120 (e.g., A→B), the set of events belonging to category 110 A are referred to as predecessor events, and the set of events belonging to category 110 B are referred to as successor events. For each SL and TL, a number of support events is counted at block 325 (FIG. 3). Support events are successor events in the (SL,TL)-neighborhood of the predecessor category 110 (successor events in the successor category 110 which are inside a volume representing the union of (SL,TL)-neighborhoods of the events in the predecessor category 110). At block 327 (FIG. 3), a P-value computation is implemented using the Poisson probability distribution function (pdf) of the observed number of support events given an expected number of support events. In order to determine the expected number of support events, the processes of the null model construction portion 330 must be executed, as described below.

The expected number of support events is computed under a null hypothesis of no relationships. That is, for example, for an edge 120 under consideration to determine if event category 110 A and event category 110 B are related (A→B), the expected number of events is the number of events in category 110 B in the (SL,TL)-neighborhood of category 110 A when there is no relationship between category 110 A and category 110 B. The density estimation (335, FIG. 3) of the successor event category 110 (category 110 B in the example being considered (A→B)) is done for each sub-region sr. The sub-region sr may be a district, a block, a zone, or the like and corresponds with a physical area Ar(sr). The total area for which event information is available may be such that a number of sub-regions of interest (e.g., a number of different districts with respective areas Ar(sr)) may be considered. The sub-region sr may be selected based on the particular event prediction application. For example, if prediction of crime is the application, then the sub-regions may be areas of the city that are expected to have different crime rates (e.g., downtown, residential area). The sub-regions can be thought of as addressing the spatial heterogeneity for a given application. For each sub-region sr, the number of events of category 110 B N_{B}(sr) are counted. Then the density of the events of category 110 B in the given sub-region sr is given by:

$${λ}_{B} ( sr ) = \frac{{N}_{B} ( sr )}{Ar ( sr )} \qquad [ EQ . 2 ]$$

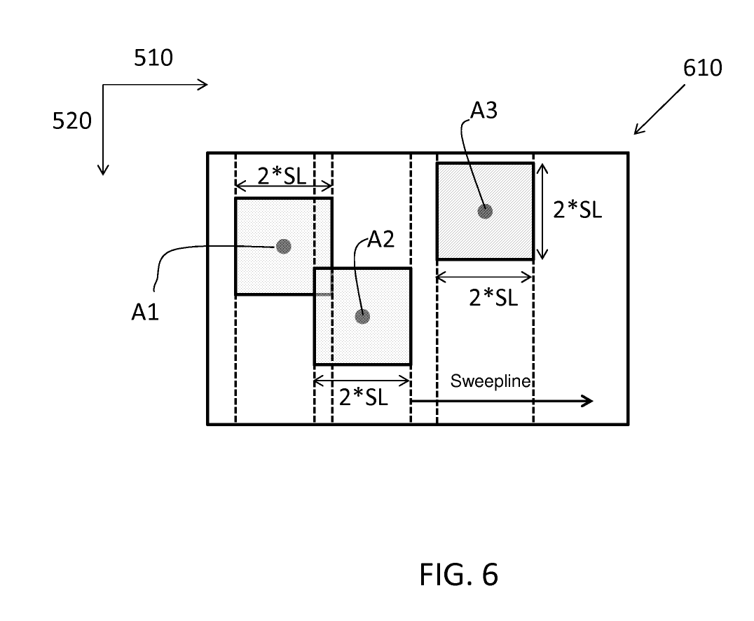

Then for each SL and TL, the (SL,TL)-neighborhood of predecessor event category 110 A (according to the exemplary A→B being considered) is computed for each sub-region sr as a volume Vol_{A}(sr,TL,SL). This computation is further detailed below with reference to FIG. 6. The expected number of support events according to the null expectation calculation at 337 (FIG. 3) is given by:

Σₛᵣλ_{B}(sr)Vol_{A}(sr,TL,SL) [EQ. 3]

This expected number is returned to be used in the computation of the P-value (327, FIG. 3), which is used in the graph pruning (317, FIG. 3). As discussed above, the P-value is checked against the statistical significance threshold 340 in the pruning process (317, FIG. 3). For example, an edge 120 may be retained when the P-value satisfies: P-value≦0.05.

FIG. 6 shows active events in category 110 A, in a sub-region 610 for a given time t, used to compute a volume according to an embodiment of the invention. Active events, represented by S_{A}(t), are events that fall within the TL time window specified by t, as shown below. FIG. 6 shows three exemplary active events A1, A2, and A3 in S_{A}(t) for an exemplary time t for a given SL in sub-region sr. These events are used to compute a volume Vol_{A}(sr,TL,SL) as detailed below. For every combination of SL and TL and for every sub-region sr, an iterative process shown below is performed. Vol_{A}(sr,TL,SL) is first initialized to 0. An iteration is performed over the time t from the smallest time 1 to the largest time T in the event dataset. For every value of time t, a time window of duration TL is considered and S_{A}(t) is determined. Again, S_{A}(t) represents active events or a set of events in category 110 A such that the time of occurrence of those events in S_{A}(t) is within the (current) specified TL range, specified by t. During each iteration, Area(t), for a given time t, is also determined. Area(t) represents the sub-region area computation (sub-region-area-compute(sr,SA(t,TL),SL)) or the union of spatial neighborhoods centered around the location of each event in S_{A} within sr. At each iteration, Area(t) is added to the current value of Vol_{A}(sr,TL,SL) at the current iteration of time t. For a given TL and SL, with tᵢ being a time of occurrence of event Aᵢ, and for each sub-region sr, the iterative process is:

Vol_{A}(sr,TL,SL) = 0
for t = 1 to T,

determine S_{A}(t) for tᵢ ≦ t ≦ tᵢ + TL
compute Area(t) = sub-region-area-compute(sr,SA(t),SL)
Vol_{A}(sr,TL,SL) = Vol_{A}(sr,TL,SL) + Area(sr,t)

end

FIG. 6 shows exemplary events A1, A2, A3 in category 110 A which are part of S_{A}(t) in a sub-region 610 at a given time t, where the two dimensional axes are axes 510 and 520, as shown in FIG. 5. At time t, the area (2*SL by 2*SL square according to the exemplary cuboids 540_1, 540_2, 540_3 shown in FIG. 5) for each event in the set S_{A}(t) is shown in FIG. 6. The Area(t) (sub-region-area-compute(sr,S_{A}(t),SL)) for the S_{A}(t) shown in FIG. 6 is the union of the spatial neighborhoods of A1, A2, and A3. According to one embodiment, the sub-region-area-compute(sr,SA(t,TL),SL) may be computed using a sweep-line algorithm when the spatial neighborhoods are square (shaded regions defined by SL), as shown in FIG. 6. In alternate embodiments, the spatial neighborhoods of the events (e.g., A1, A2, A3) may be circular or another shape, and a different known algorithm may be used to compute the area of their union.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method of characterizing relationships among spatio-temporal events, the method comprising:
receiving information specifying the spatio-temporal events and associated categories from one or more sources; and
building, using a processor, a directed acyclic graph (DAG) indicating a relationship among the categories for each of two or more space lag (SL) and time lag (TL) sets, each of the two or more SL and TL sets defining a spatio-temporal boundary such that only the spatio-temporal events and the associated categories with (SL,TL)-neighborhoods inside the respective spatio-temporal boundary are considered in building the respective DAG, the respective (SL,TL)-neighborhood of each of the spatio-temporal events being a polygonal shape defined by the respective SL and the respective TL and the respective (SL,TL)-neighborhood of each of the categories being a union of the (SL,TL)-neighborhoods of the associated spatio-temporal events.

2. The method according to claim 1, wherein, for each of the spatio-temporal boundaries associated with the two or more SL and TL sets, the building the DAG includes considering a maximum number of connections given by:
$$\frac{N ( N - 1 )}{2} ,$$
wherein
N is a number of the categories with associated spatio-temporal events within the respective spatio-temporal boundary.

3. The method according to claim 1, wherein the building the DAG, for each of the two or more SL and TL sets, includes beginning with a null set, generating one or more candidate DAGs based on adding one connection, connecting a respective predecessor category associated with predecessor events to a respective successor category associated with successor events, at each iteration, and retaining or discarding the one connection for each of the one or more candidate DAGs based on a pruning process prior to a next iteration.

4. The method according to claim 3, wherein the pruning process includes estimating a statistical significance of the one connection of each of the one or more candidate DAGs.

5. The method according to claim 4, wherein the estimating the statistical significance for each of the one or more candidate DAGs includes counting a number of support events for the respective one connection, the number of support events being a number of the respective successor events which are inside a volume representing the respective predecessor category (SL,TL)-neighborhood, and calculating an expected number of support events in the absence of a relationship between the respective predecessor category and the respective successor category.

6. The method according to claim 5, wherein the estimating the statistical significance for each of the one or more candidate DAGs includes computing a respective P-value based on the respective number of support events and the respective expected number of support events.

7. The method according to claim 5, wherein the calculating the expected number of support events includes estimating a density of the respective successor category.

8. The method according to claim 7, wherein the estimating the density of the respective successor category, for each of the one or more candidate DAGs for each of the two or more SL and TL sets, is done within a sub-region corresponding with an area within a total area for which the information is available.

9. A system to characterize relationships among spatio-temporal events, the system comprising:
an input interface configured to receive information specifying the spatio-temporal events and associated categories from one or more sources; and
a processor configured to build a directed acyclic graph (DAG) indicating a relationship among the categories for each of two or more space lag (SL) and time lag (TL) sets, each of the two or more SL and TL sets defining a spatio-temporal boundary such that only the spatio-temporal events and the associated categories with (SL,TL)-neighborhoods inside the respective spatio-temporal boundary are considered in building the respective DAG, the respective (SL,TL)-neighborhood of each of the spatio-temporal events being a polygonal shape defined by the respective SL and the respective TL and the respective (SL,TL)-neighborhood of each of the categories being a union of the (SL,TL)-neighborhoods of the associated spatio-temporal events.

10. The system according to claim 9, wherein, for each of the spatio-temporal boundaries associated with the two or more SL and TL sets, the DAG includes a maximum number of connections given by:
$$\frac{N ( N - 1 )}{2} ,$$
wherein
N is a number of the categories with associated spatio-temporal events within the respective spatio-temporal boundary.

11. The system according to claim 9, wherein, for each of the two or more SL and TL sets, the processor begins with a null set, generates one or more candidate DAGs based on adding one connection, connecting a respective predecessor category associated with predecessor events to a respective successor category associated with successor events, at each iteration, and retains or discards the one connection for each of the one or more candidate DAGs based on estimating a statistical significance of the one connection for each of the one or more candidate DAGs prior to a next iteration.

12. The system according to claim 11, wherein the processor estimates the statistical significance based on a count of a number of support events for the respective one connection, the number of support events being a number of the respective successor events which are inside a volume representing the respective predecessor category (SL,TL)-neighborhood, and a calculation of an expected number of support events in the absence of a relationship between the respective predecessor category and the respective successor category.

13. The system according to claim 12, wherein the processor estimates the statistical significance for each of the one or more candidate DAGs based on a computation of a respective P-value based on the respective number of support events and the respective expected number of support events.

14. The system according to claim 12, wherein the processor calculates the expected number of support events based on estimating a density of the respective successor category.

15. The system according to claim 14, wherein the processor estimates the density of the respective successor category for each of the one or more candidate DAGs for each of the two or more SL and TL sets within a sub-region corresponding with an area within a total area for which the information is available.

16. A computer program product comprising instructions that, when processed by a processor, cause the processor to implement a method of characterizing relationships among spatio-temporal events, the method comprising:
obtaining, from one or more sources, information specifying the spatio-temporal events and associated categories; and
building a directed acyclic graph (DAG) indicating a relationship among the categories for each of two or more space lag (SL) and time lag (TL) sets, each of the two or more SL and TL sets defining a spatio-temporal boundary such that only the spatio-temporal events and the associated categories with (SL,TL)-neighborhoods inside the respective spatio-temporal boundary are considered in building the respective DAG, the respective (SL,TL)-neighborhood of each of the spatio-temporal events being a polygonal shape defined by the respective SL and the respective TL and the respective (SL,TL)-neighborhood of each of the categories being a union of the (SL,TL)-neighborhoods of the associated spatio-temporal events.

17. The computer program product of claim 16, wherein, for each of the spatio-temporal boundaries associated with the two or more SL and TL sets, the building the DAG includes considering a maximum number of connections given by:
$$\frac{N ( N - 1 )}{2} ,$$
wherein
N is a number of the categories with associated spatio-temporal events within the respective spatio-temporal boundary.

18. The computer program product according to claim 16, wherein the building the DAG, for each of the two or more SL and TL sets, includes beginning with a null set, generating one or more candidate DAGs based on adding one connection, connecting a respective predecessor category associated with predecessor events to a respective successor category associated with successor events, at each iteration, and retaining or discarding the one connection for each of the one or more candidate DAGs based on a pruning process prior to a next iteration.

19. The computer program product according to claim 18, wherein the pruning process includes estimating a statistical significance of the one connection of each of the one or more candidate DAGs, the estimating the statistical significance for each of the one or more candidate DAGs including counting a number of support events for the respective one connection, the number of support events being a number of the respective successor events which are inside a volume representing the respective predecessor category (SL,TL)-neighborhood, and calculating an expected number of support events in the absence of a relationship between the respective predecessor category and the respective successor category.

20. The computer program product according to claim 19, wherein the calculating the expected number of support events includes estimating a density of the respective successor category, the estimating the density of the respective successor category, for each of the one or more candidate DAGs for each of the two or more SL and TL sets, being done within a sub-region corresponding with an area within a total area for which the information is available.
